(19) United States
(12) Patent Application Publication
(10) Pub. No.: US 2009/0227463 A1
(43) Pub. Date: Sep. 10, 2009

(54) AUTONOMOUS IN VITRO EVOLUTION

(76) Inventors: John H. REIF, Durham, NC (US); Erik A. Schultes, Durham, NC (US); Thomas H. Labean, Hillsborough, NC (US)

Correspondence Address: MORRISON & FOERSTER LLP, 12531 HIGH BLUFF DRIVE, SUITE 100, SAN DIEGO, CA, 92130-2040, US

(21) Appl. No.: 12/042,276

(22) Filed: Mar. 4, 2008

(51) Int. Cl. C40B 10/00; C40B 40/08

(52) U.S. Cl. 506/1; 506/17

(57) ABSTRACT

Compositions and methods for the autonomous in vitro evolution of molecules having specific properties, employing one-pot continuous evolution are disclosed.

### TECHNICAL FIELD

The invention relates to the identification of molecular species having desired properties from complex pools. The invention employs methods of autonomous in vitro evolution whereby molecular species having desired properties are selectively amplified in a continuous reaction system in a single reaction vessel.

### BACKGROUND ART

Early approaches to the identification of novel molecular species having desired properties relied on the purification of active ingredients from mixtures derived from natural sources and later, from mixtures derived from synthetic reactions (FIG. 1A). The success of these methods is limited by the technology of the purification method and the chemical complexity of the mixtures. More recently, methods of combinatorial synthesis have permitted the creation of mixtures having a high diversity of molecular species of a generic type (e.g., peptide polymers, Geysen, H. M., et al., Proc. Natl. Acad. Sci. USA (1984) 81:3998-4002, and nucleic acid polymers, Wagner, et al., U.S. 2005/6846655 B1, having a fixed and uniform number of residues). These synthetic, combinatorial mixtures, hereafter referred to as pools, are otherwise free of confounding chemical constituents and therefore have the advantageous properties of high species diversity yet, in bulk, are chemically well behaved and susceptible to exceedingly stringent purification protocols. However, diverse pools necessitate low molar abundance (i.e., low-copy number) of any particular molecular species, and even with successful purification, referred to in this context as screening, subsequent identification of the active species (usually through a tag facilitating purification, e.g., Huang A., et al., Analy. Biochem. (2003) 315:129-133, or explicit addressable physical positioning, Lockhart, D. J., et al., Nature (2000) 405:827-836) requires specialized equipment and skilled personnel to operate and are generally inapplicable to field testing (FIG. 1B).

For pools based on the combinatorial synthesis of DNA (including RNA and proteins when they are encoded by DNA templates), this fundamental limitation of low copy-number has been overcome with the employment of amplification systems such as PCR, Mullis, et al., U.S. 1990/4965188 (FIG. 1C). In this case, the extremely low molar quantities of active species yielded from purification steps, referred to in this context as the selection step, can be exponentially amplified to quantities suitable for direct identification (e.g., sequencing). In practice, there is a background of inactive species that also passes through the selection step, confounding identification of the active, or most active species, and thus the resulting pool may require additional rounds of selection and amplification before adequate enrichment is obtained, Ellington, A. E., et al., Nature (1990) 346: 818-822, Gold, et al., U.S. 1992/5270163. Having a formal equivalence to Darwinian evolutionary processes found in nature, the entire selection-amplification processes is referred to as in vitro evolution. Here, the pool is equivalent to an evolving population and the outcome of successive cycles of selection and amplification creates a dynamic equilibrium ensuring the “survival” of the “fittest” molecular species.

This iterated application of selection and amplification requires substantial manual intervention in between each round of selection and amplification (indicated by dashed-horizontal lines in FIG. 1) and, in the case of RNA and protein selections, in between the steps involving transcription, reverse-transcription and translation. This discontinuous, manual intervention arises as the result of two technical limitations. First, the reaction conditions for each step are incompatible and must be carried out in separate reaction vessels (“multiple pots”). This requires that the pool of active species be manually recovered from the previous step and appropriately reconstituted for the next step. Second, an amplification process such as PCR will indiscriminately amplify, if present, inactive species as well as active species. Hence, manual intervention involving the physical separation of the inactive species before the amplification of the active species may be required, Gold, et al., U.S. 1995/5567588.

Reducing manual intervention in in vitro evolution methods would yield significant practical advantages. For instance, in the case of emerging pathogens or bio-terrorism where a highly virulent microbe had yet to be identified, an in vitro selection experiment for molecular species that are high-affinity binders to the uncharacterized pathogen could be used for the rapid development of diagnostics, therapies, vaccines or neutralizing reagents. Expedited response would in such cases be invaluable.

Overcoming the technical limitations that require manual intervention would necessitate (1) that the selection and amplification steps be made compatible and implemented in a continuous, on going cycle and (2) that the amplification process be capable of discriminating active and inactive species, so that the pool of inactive species may be physically present during the amplification of the active species. Solutions to these technical limitations would permit the implementation of an autonomous in vitro evolution system, where active species could be isolated from pools in a single reaction vessel free of manual intervention.

Presently, in vitro evolution systems having continuous cycles of selection and amplification have been demonstrated, for both nucleic acids and proteins. For example, purified Qβ replicase enzyme, an RNA-dependent RNA polymerase, can selectively copy genomic RNA of the Qβ bacteriophage in vitro, at exponential rates. Errors inherent to the replication processes lead over time to a diversity of RNA templates, each having an intrinsic rate of replication and therefore enrichment, Mills, D. R., et al., Proc. Natl. Acad. Sci. USA (1967) 58:217-224. Hence, under the same buffer and temperature conditions, both selection and amplification steps can be sustained in a continuous manner: suitable RNA templates are selected (via the determinants of the RNA template permitting initiation on Qβ replicase, which have yet to be definitively understood) and are then immediately and directly copied (via template-directed polymerization by Qβ replicase) (FIG. 1D). Coupled reverse and forward transcription reactions have been employed to carry out the continuous in vitro evolution of bacteriophage promoter elements, Breaker, R. R., et al., Biochem. (1994) 33:11980-11986. Nathan demonstrated a form of continuous evolution of oligonucleotides with ligation, splicing, or gap filling catalytic activity, U.S. 2002/0018994. Coia, et al., demonstrated a continuous evolution system for proteins using coupled RNA replication and ribosome display, U.S. 2007/0048774.

However, these examples of continuous in vitro evolution fail to be truly autonomous because the selection step has a relatively low stringency, allowing sub-optimal and inactive variants to enter the amplification step. In practice, these continuous evolution systems require multiple-pot serial transfers of reaction aliquots into fresh buffer and reagents to achieve a significant enrichment of highly active species (indicated by the dashed-horizontal lines in FIG. 1D). Serial transfers along with brief incubation periods manually preempt the propagation of slowly replicating species resulting in a practical acceleration of the enrichment of the most active species.

To circumvent the need for multiple-pot serial transfers, the selection step must be made more stringent, reducing the background of sub-optimal molecular species permitted into the amplification step. The conjunction of a continuous in vitro evolution system with a more stringent selection step obviating the need for manual serial transfers would constitute a truly autonomous system for the search and identification of active molecular species with desired properties from pools, FIG. 1E.

FIG. 2 classifies the methods described above on the basis of their continuous/discontinuous reaction steps and their need for manual intervention (multi-pot/one-pot). SELEX, the Systematic Evolution of Ligands by Exponential Enrichment, Gold, et al., U.S. 1992/5270163, a discontinuous and multi-pot technique offers the most precise control of experimental parameters and is the most widely used mode of in vitro evolution. Continuous serial transfer evolution systems are less general than SELEX, as the selection step is intimately related to the amplification step which has thus far relied on polymerases with narrow substrate requirements. The discontinuous one-pot implementation of SELEX can be achieved in automated micro-scale devices such as capillary electrophoresis systems, Bowser, M. T., “CE-SELEX: In vitro Selection of Aptamers Using Capillary Electrophoresis” in 2006 Yearbook of Science & Technology, McGraw-Hill, New York, pp. 41-44, or microfluidic systems, Bowser, M. T., et al., “Microfluidic Selection Of Aptamers”, The Preliminary Program for 2007 Annual Meeting of The Advances in CE and Microdevice Technology for Genomic Analysis. Micro-scale devices however, place severe volumetric constraints on the pool and therefore the pool diversity.

The present invention is a continuous, one-pot in vitro evolution system that relies on a novel approach to pool design in conjunction with amplification reactions, such as Strand Displacement Amplification (SDA) technology, in order to maintain a continuous reaction cycle while minimizing background to levels sufficient to obviate multi-pot serial transfers. SDA is a process that uses both restriction enzymes and a processive polymerase to perform a dual cyclic copying reaction under isothermal conditions for DNA (Walker, G. T., et al., Proc. Natl. Acad. Sci. USA (1992) 89:392-396; Walker, G. T., et al., NAR (1992) 20:1691-1696; Walker, U.S. Pat. No. 5,455,166, Walker, et al., U.S. Pat. No. 5,736,365, Fraiser, et al., U.S. Pat. No. 5,744,311) and RNA (Pearson, et al., U.S. Pat. No. 5,916,779).

### DISCLOSURE OF THE INVENTION

The present invention provides unique compositions and methods that combine all the essential requirements for autonomous in vitro evolution of oligonucleotides in a single reaction vessel, requiring no manual intervention after the system is prepared and initiated. This autonomous in vitro evolution system permits a continuous, one-pot selection-amplification reaction cycle that maintains stringent selective amplification of active species even though inactive species are physically and simultaneously present.

The invention relies on an oligonucleotide pool design that fuses a degenerate sub-sequence with a designed structural format that will induce an specific and intended state change if and only if it performs a desired task. The state change may be, but is not limited to, conformational changes involving metastable transitions or the breaking of covalent bonds. Whatever form the state change embodies, this task-dependent process is referred to as Self-Activation for Selective Amplification (SASA). The particular form of the SASA process is intentionally designed so as to permit subsequent amplification utilizing any available isothermal method, for example, Strand Displacement Amplification (SDA). Alternatively, a novel system, Multi-Prime Amplification (MPA), a method that is independent of restriction enzymes may be used. Any form of the SASA may be combined with any isothermal method of amplification, regardless of the choice of SASA. The reagents for both SASA and the amplification method are contained in the same composition.

Once the reaction system is prepared and initiated, the autonomous in vitro evolution system is incubated under appropriate conditions, producing substantial quantities of the oligonucleotide sequence(s) that perform a desired biochemical task. Autonomous evolution is simple to carry out, adaptable to field use, and produces an amount of product suitable for identification using standard methods such as DNA sequencing.

### BRIEF DESCRIPTION OF THE DRAWINGS

FIG. 1 diagrams methods used to identify active ingredients from complex mixtures: A) Traditional chemical purification; B) Screening from synthetic pools; C) SELEX based in vitro evolution (discontinuous evolution); D) Continuous evolution with serial transfers; and E) One-pot, continuous evolution (Autonomous Evolution). FIGS. 1A-1D are prior art.

FIG. 2 classifies in vitro evolution methods characterized by compatibility of the reaction steps (continuous/discontinuous) and requirements for manual intervention (one-pot/multi-pot). Autonomous evolution is defined by a continuous, one-pot system.

FIG. 3A shows the generic, inactive, metastable secondary structure of oligonucleotides from a BISS pool. FIG. 3B shows the BISS structure of an oligonucleotide species in active form as a result of binding to target.

FIG. 4 outlines a BISS-SDA embodiment of autonomous evolution.

FIGS. 5A-5C show a schematic of one negative selection mechanism for reduction of false positive background.

FIGS. 6A and 6B show a schematic of the SASA mechanism for self-cleaving nucleic acids.

FIGS. 7A and 7B show a schematic of the isothermal, restriction-enzyme free multi-prime amplification (MPA) reaction. Inert, terminating double-strand template copies are denoted by octagons. New template copies after step 12 are indicated only by alphanumeric symbols. The symbol * denotes reverse-complementary sequences.

FIG. 8 outlines the relationships between the strands depicted in FIG. 7. Inert, terminating double-strand template copies are in bold.

FIG. 9 is a schematic of the SASA mechanism for self-ligating ribozymes.

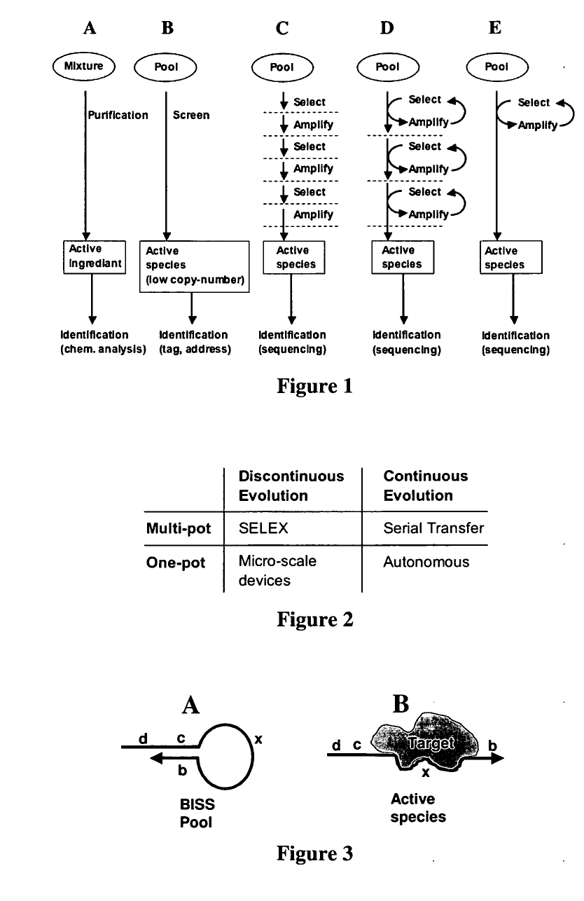

### MODES OF CARRYING OUT THE INVENTION

### DEFINITIONS

Discontinuous Evolution: In vitro selection protocol involving a series of incompatible reaction steps, that must be performed in discrete steps having a sequential order.

Continuous Evolution: In vitro selection protocol composed of non-interfering reaction steps that can be implemented in parallel and in an asynchronous manner.

Multi-pot reactions: Implementing an in vitro procedure using more than a single reaction vessel.

One-pot reactions: Implementing an in vitro procedure using only a single reaction vessel.

Autonomous Evolution: In vitro selection protocol that is continuous and one-pot.

Auto-blockers: Oligonucleotides that are the reverse complements of specific, identified unwanted pool species that are known to target autonomous evolution reaction reagents. By adding auto-blockers to pools in excess, species that would otherwise interfere with the selection are rendered inert.

Self-Constrained Pool: A pool in which specific, identified pool species that are known to target autonomous evolution reaction reagents have been inactivated with auto-blockers or eliminated by a single round of discontinuous selection.

Pool Initialization: A process that ensures all members of the pool assume the inactive state of the SASA mechanism before autonomous evolution begins.

Strand Displacement Amplification (SDA): A one-pot, isothermal, exponential, in vitro nucleic acid amplification technique utilizing primers containing restriction sites, the appropriate restriction enzymes and a processive polymerase. Primer sequences susceptible to cleavage by the restriction enzyme bind to a suitable template and are extended using hemiphosphorothioate nucleotides that are resistant to cleavage. The primers are then nicked, permitting additional rounds of extension with concomitant displacement of the existing strand. The accumulating displaced strands reenter the reaction cycle resulting in an exponential increase in template copies.

Multi-Prime Amplification (MPA): A one-pot, isothermal, exponential, in vitro nucleic acid amplification technique that is further described below. It utilizes a series of primers that sequentially prime from proximal to distal positions, both positive and negative strand extension by a polymerase. Each set of primers produces one round of amplification resulting in two additional product strands.

Binding-Induced Strand Separation (BISS): A specific embodiment of the SASA process, whereby subsequences in a single oligonucleotide are hybridized in the absence of a specified Target, but become physically separated when the oligonucleotide binds to the Target. The strand separation makes the oligonucleotide susceptible to amplification.

Cleavage-Induced Topological Opening (CITO): A specific embodiment of the SASA process, whereby a circularized species becomes activated upon linearization via backbone cleavage at the junction of the a and b subsequences. The linearized, active form is then susceptible to amplification. Cleavage may be induced by self-catalytic sequences composing the circularized species or by transduction of suitable energy or allosteric effectors through chemical catalysts in solution or tethered to the circularized species.

Self-Activation of Selective Amplification (SASA): A process whereby an active species of a pool, upon performing the desired task (e.g., binding, catalysis), sustains a specific state change, making it susceptible to the amplification reaction. Pools having an SASA mechanism can have active species undergo selective amplification without prior purification from inactive species.

SASA pools are composed of nucleic acids (including RNA, DNA, and synthetic chemical modifications thereof, Silverman, S. K., “In Vitro Selection and Application of Nucleic Acid Enzymes,” Advanced Review, (2007) in Wiley Encyclopedia of Chemical Biology, ed. Tadhg P. Begley). The pools reflect a design strategy coupling a metastable molecular switch subsequence(s) with a degenerate subsequence that acts as the candidate for performing a desired molecular task, such as for example, binding a target molecule. If the degenerate subsequence successfully performs the desired task, the molecular switch is flipped from its inactive state to its active state, making this particular molecular species available for amplification. For species that do not perform the desired task, the molecular switch remains in the inactive state, making it inert to the amplification process. In this way, active species become self-activated for the subsequent amplification reaction that will be selective even in the presence of inactive species.

The SASA pool design can take many forms. In one embodiment seeking aptamers for molecular targets, oligonucleotide species have reverse-complement subsequences that hybridize, forming a hairpin structured inactive state, with the degenerate sequence forming the “loop” which, in successful members of the pool, binds the target. Active species that bind to the target result in “opening” the stem, and thus expose the strands to primer binding for enzyme-mediated polymerization reactions. This approach can be termed Binding Induced Strand Separation (BISS) as defined above.

In this embodiment, a target is contacted with the prepared autonomous evolution reaction mixture, incubated for a sufficient time at constant temperature and the resulting active species identified. In some instances, such as where active species are rare or present only at low activity, it may be desirable to alter the reaction conditions during the time course of the selection, enabling the increase or decrease in the stringency of the selection steps. For instance, permissive conditions may be necessary early in the time course to initiate amplification for a few active species, but then stringent conditions may be used later in the time course to enrich only the optimal species.

Altering the reaction conditions in order to modulate the stringency of selection can be accomplished by the real-time addition of buffer components and/or by changing the incubation temperature. For example, with respect to the BISS mechanism, the addition of monovalent or divalent salts can stabilize the helical elements of initialized pool nucleic acids, decreasing their propensity to become amplified. This has the effect of increasing stringency of the selection. Conversely, the addition of chelating agents, such EDTA, can reduce the effective concentration of divalent metals, resulting in less stable helical interactions, with a concomitant increase in the ability to undergo separation. The stringency of the selection is set as a compromise between competing inter- and intra-molecular biding. While it may be difficult to predict in advance how altering the reaction conditions may effect this equilibrium, the rapid execution of the autonomous selection system permits the real-time, economical, empirical optimization of reaction conditions. In other words, the selection can be conveniently repeated in a controlled manner, testing reaction conditions—an option difficult to conceive of using traditional SELEX techniques. Alternatively, an array of reactions may be conducted simultaneously to explore the reaction conditions.

Other reaction parameters that can be used to modulate the stringency of selection include, but are not limited to buffers, pH, crowding agents, temperature ramps and incubation times. The selection processes may also be cycled through stringent and permissive phases by the real-time dynamic alternating of conditions such as temperature or iterative additions of EDTA and divalent ions, such as magnesium.

Although the primary advantage of autonomous in vitro evolution is the obviating of manual intervention, there may still remain instances where serial transfers, reminiscent of traditional continuous evolution experiments, e.g., McGinness, K. E., et al., Chemistry & Biology (2002) 9:585-596, may be advantageous. In these cases, aliquots of an autonomous evolution reaction are manually transferred to new tubes having identical reaction mixtures, including target, but excluding pool. This aliquot transfer therefore seeds the new tube with a small amount of pool that is already enriched in active species, leaving behind the vast majority of inactive or less species. Serial transfers facilitate the enrichment of the active species, effectively increasing the stringency of the selection, by physical separation. Iterative application of serial transfer, where time intervals between transfers decreases, results in a dynamic selective regime that changes from permissive to stringent.

Another embodiment seeks self-cleaving nucleic acid enzymes. Oligonucleotide species having constant primer binding subsequences and a degenerate subsequence are circularized (inactive state). Species that can self-catalyze the appropriate cleavage reaction opening the circle (active state), can expose the strands to primer binding for polymerization reactions. Such self-cleaving nucleic acids are useful as laboratory reagents as they are substitutes for restriction enzymes and are also useful in controlling gene expression. Self-cleaving nucleic acid enzymes can also be engineered to operate, by virtue of altering modular substrate recognition sub-sequences, as specific silencers of gene expression. In this case, self-cleaving nucleic acid enzymes are given substrate recognition sub-sequences that target (by reverse complementarity) a particular messenger RNA sequence in a cell, e.g., Hiroaki, K., et al., Experimental Medicine (2000) 18:381-386. Any such nucleic acid enzyme that can be discovered becomes a valuable candidate for such powerful technology.

In still another embodiment, the desired activity is that of a ligase, which provides alternatives for standard ligase reagents currently available in the art.

The creation of an SASA pool begins as a conventional solid-phase oligonucleotide synthesis followed by an appropriate purification. But unlike conventional oligonucleotide combinatorial libraries, the SASA pool of an autonomous evolution system may be modified according to two procedures.

First, the primary advantage of an autonomous evolution system (continuous and one-pot) also engenders its greatest risk: some species in the pool may bind to or interfere with reaction components and may lead to their amplification at the expense of active species and/or such interference could simply poison the amplification reaction. In principle, this interaction of the pool with the reaction system is not a significant problem, as spurious intermolecular interactions is a potential problem that is routinely overcome in any high-diversity experiment seeking members of a pool that bind to a target. Because the target is present in excess quantities over the components of the pool, and by virtue of exponential amplification, it is only the non-interfering active species that are in excess and come to dominate the pool. In practice, binding affinities can vary by orders of magnitude and if the active species binding the desired target has a lower affinity than that of another species binding an amplification reagent, then the enrichment equilibrium may favor the other species.

To minimize this risk, the nucleic acid pools of an autonomous evolution system may undergo a preparative process of “focusing” using the methods demonstrated by Layzer, et al., Oligonucleotides (2007) 17:1-11. In this so-called “DeSELEX” method, species that are unwanted, yet dominating the outcome of the selection are effectively eliminated by combining the pool with excess oligonucleotides specifically designed to bind the unwanted sequences via sequence complementarities. In the present invention, an autonomous evolution pool first undergoes a discontinuous SELEX against each component of the autonomous evolution reaction mix (e.g., Phi-29 polymerase, restriction enzymes, primers P & Q, as described in Example 1). Any pool species isolated from these initial SELEX experiments are sequenced and this information is used to design full-length reverse complement oligonucleotides referred to as “auto-blockers”. When auto-blockers are then added back to the pool in 5-fold molar excess, and the resulting pool-auto-blocker mixture undergoes a single thermal cycle, species that would spuriously target the autonomous evolution reagents will form highly stable, inert, double-stranded helices, thus effectively preempting their interaction with the reaction or entering the amplification process. These modified pools, referred to as being “self-constrained”, can then be used directly in autonomous evolution system, or can undergo a preparative round of discontinuous selection and re-amplification, resulting in a self-constrained pool free of the need for auto-blockers. This “focused” self-constrained pool has the advantage that copies of the pool can be propagated indefinitely for additional selections, without ever having to repeat the addition of auto-blockers.

In keeping with the goal of rapid identification of aptamers, known and purified targets are not required. For example, for a pool DeSELEXed not only against the autonomous evolution system itself, but also against human blood, one could select aptamers to an unknown bloodborne pathogen by contacting the autonomous evolution system with a raw blood sample.

A second pool modification unique to autonomous evolution is the “Initialization,” which may be required in some cases. Here, a pool is treated in such a way as to ensure that each species in the pool is set to its inactive state, if this state is not spontaneous. Pool Initialization prevents false positive amplification of inactive species. Examples of Pool Initialization are a simple heating cycle (as in the case of annealing hairpin structures) or an enzymatic circularization of pool oligonucleotides. Initialized pools should be rigorously purified of uninitialized species, as these will result in false positives. This can be accomplished using various forms of gel electrophoresis. Depending on the SASA mechanism, pool Initialization may be performed in the presence of auto-blocker oligonucleotides.

The mode of amplification must be (1) exponential and (2) such that inactive species are not amplified and do not interfere with amplification of active species. The standard PCR reaction is an unsuitable mode of amplification in any continuous evolution system as the heating cycle will inactivate other critical reagents in the reaction mixture. In particular, a single high-temperature thermocycle may activate inactive species of the pool, inactivate active species of the pool, and/or prime the pool, both frustrating and competing with the amplification dynamics of the active species. Although monotonic temperature ramps may have utility in an autonomous evolution system, an isothermal amplification process is itself a general mode of implementation.

Various amplification systems may be employed. In one embodiment, the amplification process is an RNA-dependent RNA polymerase, such as the Qβ replicase. This enzyme produces positive and negative copies of RNA sequences using positive and negative templates without additional primer sequences.

In another embodiment, the amplification process utilizes a DNA-dependent RNA polymerase, such as T7, and an RNA-dependent DNA polymerase, i.e., Reverse Transcriptase. This enzyme pair produces RNA and DNA copies of DNA and RNA templates.

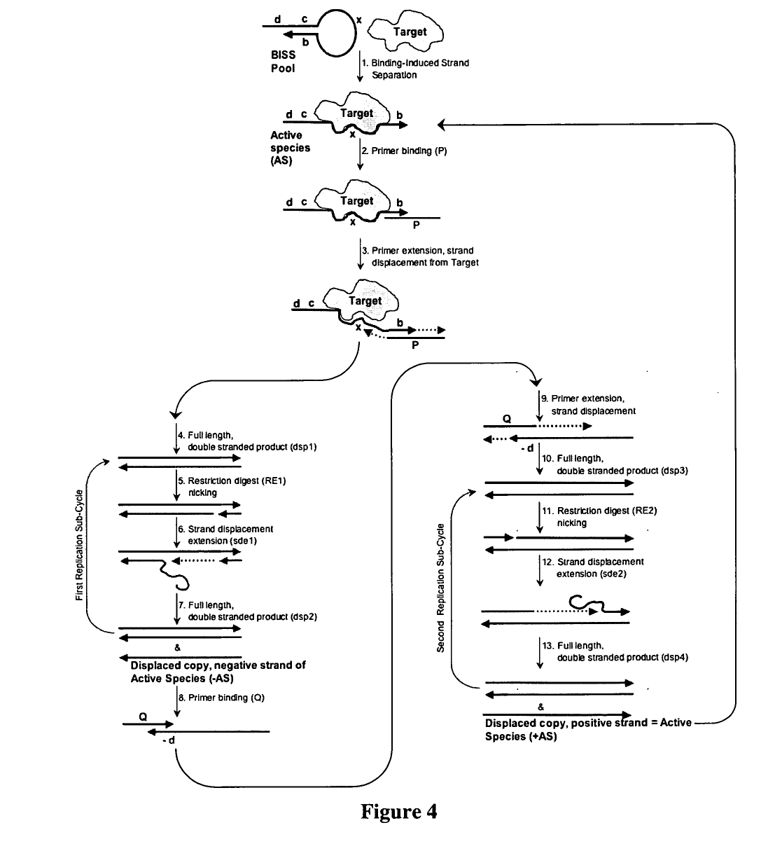

In another embodiment, the amplification process is Strand Displacement Amplification (SDA), known in the art and described in detail in Example 1 and depicted in FIG. 4.

SDA has utility as a general method, as its only requirement for oligonucleotide amplification is the exposure of an arbitrary-sequence primer-binding site. However, a large number of other isothermal oligonucleotide amplification methods are also available. The simplest of these makes use of de novo initiation, a property of certain polymerases that initiate polymerization on a template strand using a promoter sequence, independent of a primer sequence. Notably, for suitable templates the copied, negative strand can it self be used as a template to produce a copy of the original, positive strand, Tyagi, S., et al., Proc. Natl. Acad. Sci. USA (1996) 93:5395-5400.

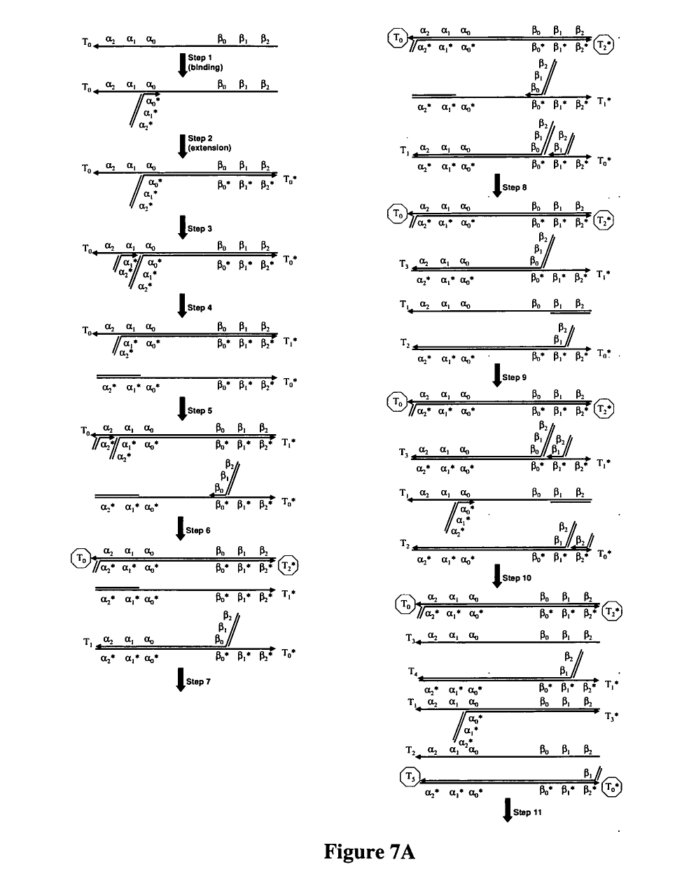

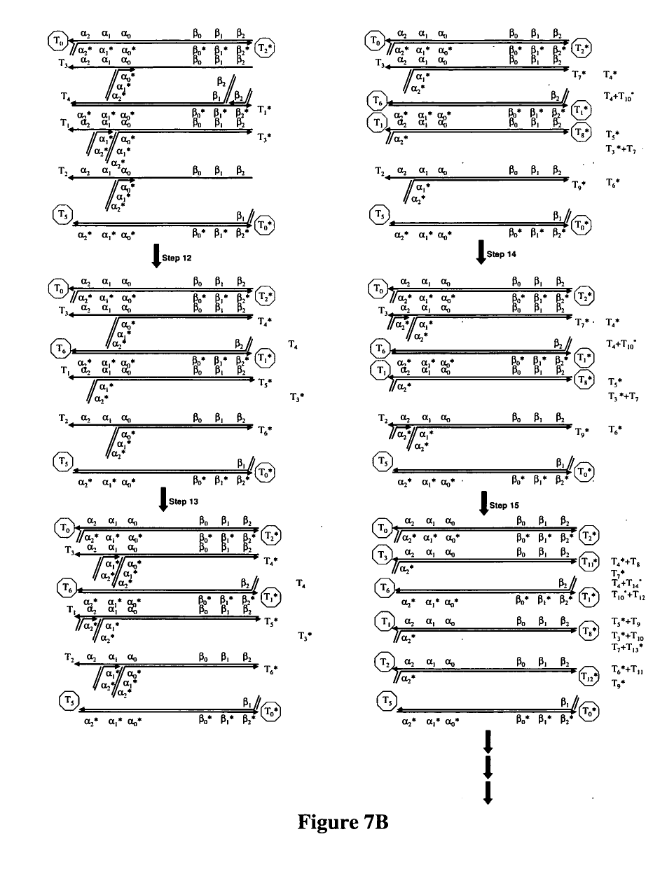

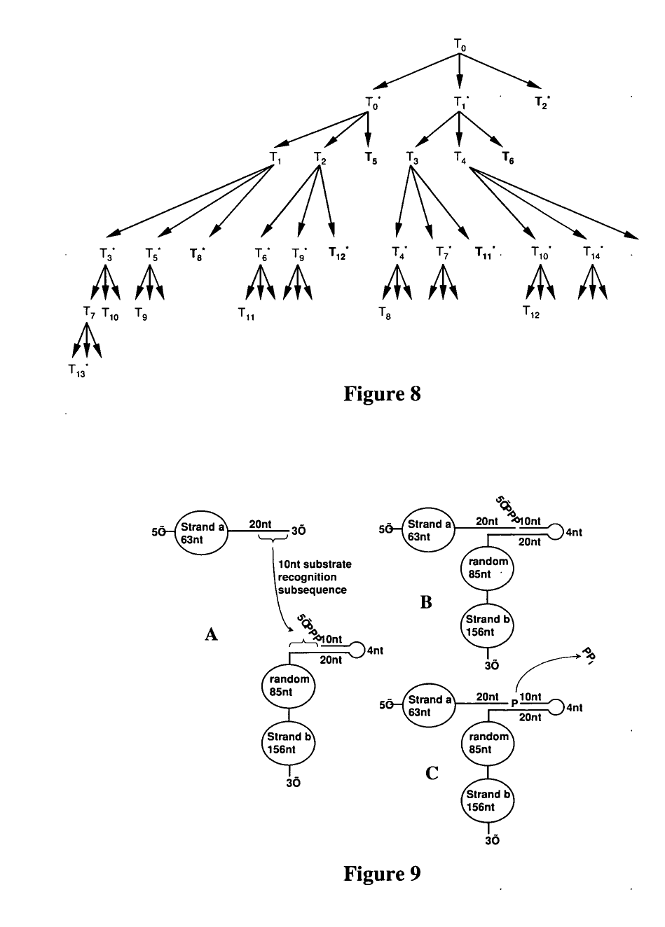

In another embodiment, the amplification process is Multi-Prime Amplification (MPA), described in detail in Example 4 and depicted in FIGS. 7 and 8.

It may also be beneficial to induce mutations in the candidate sequences. Active species, when amplified, have a small but finite probability of sustaining a mutation. Ordinarily, error rates are so low (i.e., fidelity is so high) that the number and activity of the mutated species is negligible. Intrinsic rates of mutation for DNA and RNA polymerases typically used in biotechnology range between 10⁻⁴ and 10⁻⁶, per nucleotide, Tindall, K. R., et al., (1988) Biochemistry 27: 6008-6013, Fersht, A. R., et al., Proc. Natl. Acad. Sci. USA (1981) 78:4251-4255. However, depending on the nature of the in vitro evolution process, these rare mutant species may be a viable source of pool diversity for the subsequent round of selection and amplification, as was noted in the original Qβ-replicase amplification experiments, Mills, D. R., et al., Proc. Natl. Acad. Sci. USA (1967) 58:217-224. If fortuitously active, these rare mutants can compete with other active species, may become enriched in the pool, and may eventually come to dominate the outcome of the selection. Furthermore, as these mutant species undergo still numerous cycles of amplification, they my sustain additional mutations, so that the final outcome of the selection is sequence with multiple, cooperatively interacting mutations that is far superior to the original active species that initiated the first amplification process.

To exploit this capability of exploring the local mutational neighborhoods of active species, often times in conventional SELEX applications, the fidelity of the amplification step is purposefully lowered. This modulated joint amplification-mutation procedure creates a higher, yet still focused pool diversity. Modulating polymerase fidelity is typically accomplished by altering divalent metal ion concentration in the amplification reaction conditions, Ekland, E. H., et al., Science (1995) 269:364-370.

Not only can the same process can be implemented in the present invention, but the autonomous evolution system is particularly well suited for a dynamic fidelity modulation with superior optimization potential. The low-fidelity conditions can be operating continuously following the initiation of the reaction, or may be activated after some period of time after the system is initiated with the addition of target, by for example, spiking the reaction with a chelating agent such as EDTA, thus lowering the effective magnesium ion concentration and increasing the mutation rate. The low-fidelity conditions may be initiated at any time, and in any incremental step-wise procedure. The fidelity of the amplification processes may also be cycled through high and low phases by the alternating additions of EDTA and magnesium. Other methods of modulating lower fidelity include the use of mutated polymerases, the use of nucleotide analogues and the alteration of other reactions conditions including monovalent ion concentration, pH, and temperature.

The amplification systems that employ primers can be multiplexed by providing more than one primer pair. For example, oligonucleotides P and Q that constitute elements of the SDA amplification reaction of Example 1 and FIG. 4 have the primary function of priming the polymerase mediated extension of the active species. These sequences are somewhat arbitrary and many unique sequence combinations can be obtained that do not interfere with each other or with other reaction components. Because unique sets of P and Q primers can function as mediators of different replication cycles of the SDA (in the same tube), analogous primers, R and S can function as mediators of different autonomous evolution experiments in the same tube. Thus, multiplicities of unique primer pairs permit the autonomous evolution of multiple pools simultaneously. Self-activated species from different pools enter into distinct selective, exponential amplification pathways running in parallel, each amplification method kept distinct by the unique primer combinations.

The multiplexing of distinct pools has advantages in terms of scaling and error minimization. For example, pools having different SASA mechanisms that are appropriate for different targets can be combined in a single autonomous evolution reaction. Although the reaction volumes would have to be multiplied by the number of pools multiplexed, the waiting time for the selections are reduced by the same factor.

Furthermore, pools may have, for many different possible reasons, an intrinsically high background rate of false positives. This rate may, at times, be related to circumstances idiosyncratic to the combination of the target and the particular pool design (SASA mechanism). By multiplexing different pools with different SASA mechanisms, a single autonomous evolution experiment can increase the probability of a successful outcome, even though an particular pool may produce spurious results.

In the examples set forth below, particular illustrations of autonomous in vitro evolution are given with particular embodiments of the pool, the SASA mechanism, a description of the selection step and the interaction of the active species with the amplification step in each case.

The following examples are offered to illustrate but not to limit the invention.

### EXAMPLE 1

### Self-Activation by Binding-Induced Strand Separation with Strand Displacement Amplification

In this incarnation of the present invention, the SASA mechanism is Binding-Induced Strand Separation (BISS), and results in identification of a nucleotide sequence that binds to a desired target. The BISS SASA mechanism activates pool species that bind specific targets. In BISS, pool oligonucleotides have hybridized subsequences in the absence of a specified target, but the subsequences are separated upon binding of the degenerate subsequence to said target, as shown in FIG. 3.

In the combinatorial pool, the generic form of the BISS oligonucleotide is composed of the fixed subsequences d, c, and b (where c and b are reverse complements) and the subsequence x (which, in successful members of the pool, will bind to target) has a fixed length and is degenerate. The magnitude of the physical separation of the complementary sequences upon binding of X to target is not critical, so long as the distance is sufficient to disrupt base pairing and allow interactions with other reaction components that facilitate the next step of the reaction. In this case, the pool is Initialized by a single thermal cycle and annealing. The target may be an organic or inorganic molecule, surfaces, or nanomaterials such as nanocrystals or nanoparticles, or targets derived from biological sources, such as the protein thrombin, Bock, L. C., et al., Nature (1992) 355:564-566.

Essential to the BISS self-activation mechanism, the c-b hybridization stem is designed to be a metastable secondary structure, Ehses, S., et al., Biochem. Biophys. Methods (2005) 63:170-186. Absent the target, the c-b subsequences are paired and subsequence b is protected from possible hybridization with other strands. When the target is present, and if x should bind to the target, the c-b subsequences are forced to separate, exposing subsequence b as a potential substrate initiating an SDA cascade, as shown in FIG. 4.

It is possible that a subpopulation of strands will bind tightly to target but for one reason or another, will not be amplified. For example, some sequences upon binding will not achieve strand separation. These species will not be self-activated and will therefore not be amplified. Or, though some sequences may bind the target and achieve strand separation, they may bind with such high affinity that the polymerase will not be able to displace the strand from the target, thus preventing subsequent amplification. There is however evidence to suggest that aptamer-type binding to arbitrary targets occurs with much lower energy than those of hybridized oligonucleotides. This would suggest that sequences too tightly bound for polymerase displacement are exceedingly rare. For example, RNA aptamers to theophylline bind with free energies between −7.0 and −9.0 kcal/mol (Gouda, H., et al., Biopolymers (2003) 68:16-34) whereas the free energy of an 18 nucleotide DNA-DNA helix was measured to be −21.0 kcal/mol (Kim, D-K., et al., Japanese Journal of Applied Physics (2006) 45:509-512). In any case, subpopulations of strands that bind tightly to target but are not amplified are nonetheless inert, and will not interfere with the binding and selection of species that can pass each of these steps required for in vitro evolution.

The choice of sequences b and c will determine the strength of the binding between b and c, and thus the stability of the hybridization stem. This choice of sequences b and c is determined as a compromise between stable base-pairing minimizing nonspecific opening and base-pairing susceptible to opening upon specific binding of x. In the BISS approach, there is the potential for a bias against the most tightly bound aptamers via an inhibition of amplification, so that the processivity of Phi-29 (the SDA polymerase of the preferred embodiment) sets the upper-bound of the binding affinity of aptamers recovered from this technique, since Phi-29 has to displace the aptamer from the target, in order for the aptamer to participate in amplification. The Phi-29 activity demonstrates that the enzyme is capable of displacing oligonucleotides with binding energies of at least reverse complementary nucleic acid helices.

The Strand Displacement Amplification (SDA) cascade utilizes primer sequences, restriction enzymes and a polymerase to amplify a nucleic acid template sequence at exponential rates under isothermal conditions. SDA is one embodiment for amplification, although alternative methods could be employed. As implemented here, the SDA is a 13 step reaction cycle having two distinct template replication sub-cycles, as shown in FIG. 4. Each sub-cycle yields one copy of the template (in one case, the positive strand, in the other, the negative strand). The replication sub-cycles operate independently, in parallel, and in an asynchronous manner yielding the exponential amplification of the template strand.

Some embodiments of SDA have used the HincII restriction endonuclease and an exonuclease deficient Klenow polymerase to drive the reaction, while this illustrative embodiment uses the processive DNA polymerase, Phi-29. It is essential to this SDA that hemiphosphorothioate mononucleotide analogues are supplied in the reaction mixture in order to protect newly synthesized strands from restriction digestion.

In the present invention, the SDA cascade initiates when an oligonucleotide primer (primer P in FIG. 4, step 2) anneals to the exposed subsequence b. The binding of P to subsequence b permits DNA polymerase to extend both b and P, creating double stranded product, dsp1, steps 3 and 4.

This product, dsp1, is then substrate for the first restriction enzyme, RE1, although because the polymerization reaction uses nucleotide monomers modified to prevent cutting of newly synthesized strands, only the restriction site contained in the original strand P is susceptible to cleavage. This results in nicking at a single position in the double stranded product, dsp1, step 5. The 5′-end of the nicked primer P is then extended (dotted lines in steps 3, 6, 9, and 12 in FIG. 4) via a strand displacement polymerization reaction catalyzed by the processive DNA polymerase, step 6. The product of this second polymerization reaction is a double stranded product, dsp2, of the displaced negative-strand copy of the Active Species (−AS) that bound to the Target (in step 1), step 7. At this point in the SDA reaction cycle, the −AS strand continues to other reactions (see below) while dsp2 renters at step 5, producing still additional copies of −AS. Hence, steps 5, 6, and 7 are referred to as the First Replication Sub-Cycle.

In a manner analogous to steps 2-4, an oligonucleotide primer, Q, anneals to the −AS strand at subsequence −d (the reverse complement of subsequence d of the active species, steps 0-3), permitting DNA polymerase to extend both −AS and Q, creating double stranded product, dsp3, steps 8-10. In steps 8 and 9, the −AS strand could conceivably fold as depicted in step 0 for its AS analogue. Subsequence −d therefore acts a toe-hold for Q binding and subsequent extension with the processive polymerase.

In a manner analogous to the steps of the First Replication Sub-Cycle, dsp3 is nicked by RE2 and the 5′-end of the nicked primer Q is then extended via strand displacement polymerization, steps 11-13. The resulting product dsp4, renters at step 11, thus constituting the Second Replication Sub-Cycle. The displaced strand from the Second Replication Sub-Cycle is a positive-strand copy of the Active Species (+AS) that bound to the Target (in step 1). At this point in the SDA reaction cycle, the single-stranded +AS is free to anneal to itself acquiring the generic form of the BISS pool and/or to bind to additional Target molecules, reinitiating the SDA cycle at step 2 in FIG. 4.

Hence, the coupled BISS-SDA reaction cycle, when properly incubated at controlled temperature, will autonomously amplify oligonucleotides sequences from the pool that bind to the Target. After initiating the reaction and permitting adequate incubation time, the amplified aptamer species is/are identified using standard sequencing protocols. The aptamers may also be PCR amplified (using primers for subsequences d and b) and/or cloned.

### EXAMPLE 2

### BISS Selection Augmented with Negative Selection

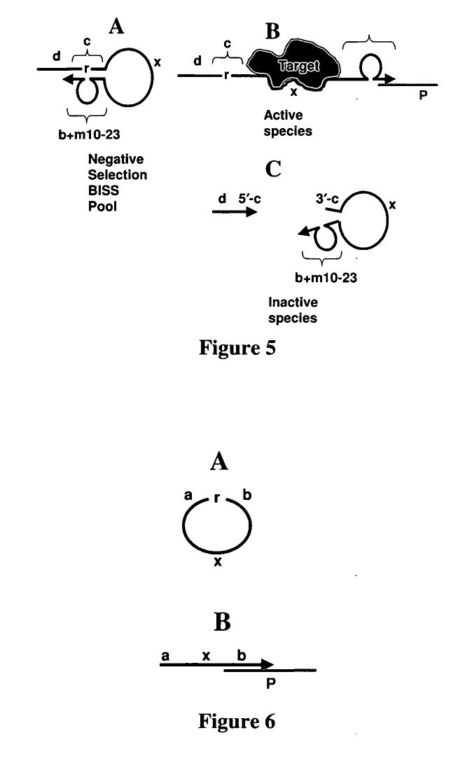

In this incarnation, the BISS-SDA autonomous evolution method of Example 1 is augmented with a negative selection system that minimizes the background amplification of inactive species that could confound the identification of desired species. In this system, the subsequence b of the BISS pool contains a modified 10-23 self-cleaving deoxyribozyme (b+m10−23), Levy, M., et al., Proc. Natl. Acad. Sci. USA (2003) 100:6416-6421, as shown in FIG. 5A. The deoxyribozyme is a variant having reduced reaction rate. Subsequence c contains within it a single-ribonucleotide linkage, acting as substrate for the 10-23 deoxyribozyme. This ribo-linkage does not interfere with primer binding or extension by polymerase. Active species will undergo SDA amplification as in Example 1 (initial primer binding of P as in FIG. 5B). Inactive species that do not bind the target, because of the continued proximity of b and c, will eventually self-cleave subsequence c, removing subsequence d. This permanently prevents that species from undergoing exponential amplification by the SDA process, FIG. 5C. Over the course of the incubation, as active species are amplified, inactive species will be degrading. The combination of positive and negative selection in a one-pot system will reduce the occurrence of false positives and shorten incubation time.

### EXAMPLE 3

### Self-Activation by Cleavage-Induced Topological Opening

In this embodiment, nucleotide sequences that can behave as cleavage enzymes are identified.

The generic sequence of the DNA pool is composed of the fixed subsequences a and b and the subsequence x which is the candidate. It has a fixed length but is degenerate, FIG. 6. The pool is initialized by an enzymatic ligation, preferably with a specialized ligation enzyme such as the commercially available CircLigase™ from EPICENTRE® Biotechnologies. This SASA mechanism may be termed Cleavage-Induced Topological Opening (CITO).

In the combinatorial pool, the generic form of the CITO oligonucleotide is circularized to the closed, inactive form (FIG. 6A) that becomes linearized to the open, active form (FIG. 6B) when the phosphodiester backbone linkage is cleaved at the junction of the a and b subsequences due to the activity of the successful embodiment of the degenerate sequence x. This exposes subsequence b for binding to SDA primer P, as in step 2 of FIG. 4 in Example 1, thus entering the SDA reaction cycle.

Thus, the enzymatic properties of subsequence x of circularized species having the ability to catalyze a self-cleavage reaction at the a-b subsequence junction will undergo amplification. In this example, a single ribo-junction (r) is used to separate the subsequences a and b (FIG. 6A). The outcome of this autonomous evolution reaction will therefore be DNA enzymes catalyzing ribonucleotide cleavage. The amplified products, when sequenced will therefore yield nucleic acid enzymes for the sequence-specific cleavage of nucleic acid substrates having the a-b sequence motif, and can be used as restriction enzymes.

### EXAMPLE 4

### Multi-Prime Amplification

As an alternative to SDA, an amplification system based on the strand propagation cascade of an isothermal, restriction enzyme-free reaction using multiple, specifically designed primers and referred to as Multi-Prime Amplification (MPA) may be used.

In MPA, the original template strand (T₀) undergoes multiple cycles of template directed polymerization creating positive and negative strands (negative strands, i.e., reverse complements, are denoted by *). The synthesis of each copy is mediated by a sequential series of primer extension reactions that bind to specific 5′ and 3′ subsequences of the positive and negative copies. In FIG. 7, these subsequences are labeled as α₁, α₂, α₃ and β₁, β₂, β₃, for the 5′ and 3′ subsequences, respectively. The primers binding each subsequence (a unique primer for each subsequence) have tails that encode all the subsequences positioned from their binding site upstream of the direction of polymerization. These tails are protected from interference by complementary oligonucleotides that form double-strand helical structures (depicted in FIG. 7 as double lines). Furthermore, the binding efficiencies of each subsequence have been optimized to probabilistically control the sequence of binding events to any given template (from proximal to distal ends). The sequence between the α and β subsequences is, when applied to the SASA of the present invention, the degenerate pool sequence.

Although depicted as a series of discrete steps for clarity of presentation (arrows in FIG. 7), the MPA reaction is synchronous. As depicted, odd numbered steps show primer binding, even numbered steps show polymerase mediated extension of bound primers into template copies. Template copies produced with extreme 5′ and 3′ primers result in double-strand products that are thereafter inert to replication (octagons). Each template copy ultimately generates two additional template copies and the number of cycles of replication is determined by the number of unique subsequences and α-β primer-pairs. While the subsequences shown here are capable of only 3 rounds of replication, in general, there could be 25 to 30 unique subsequences and α-β primer-pairs. After step 12 in FIG. 7, new template copies are represented alphanumerically only (shown right). FIG. 8 diagrams the genetic relationships between the strands depicted in FIG. 7. Inert, terminating double-strand template copies are shown in bold.

This method of amplification may readily be applied where, for example, the a-b subsequences of Example 3 are replaced with the series of α-β subsequences as primer-pairs.

### EXAMPLE 5

### Amplification by Polymerases with de novo Initiation

In this Example, a nucleotide sequence that can behave as a ligase is identified.

The highly efficient Qβ replicase is used as a means of amplification for potentially self-ligating ribozymes. The pool design is based on the substrate for this replicase, the MDV-1 (+) RNA, a 219 nucleotide RNA sequence that undergoes highly efficient amplification by Qβ replicase. As diagrammed in FIG. 9, the MDV-1 (+) RNA is synthesized in two potions: The first 63 nucleotides of the 5′-end (strand a), and last 156 nucleotides of the 3′-end (strand b). The 3′-end of strand a has an 20 nucleotide sequence that acts as a recognition sequence. On the 5′-end of strand b there are additional 85 nucleotides forming the degenerate pool candidate sequence followed upstream by an additional 34 nucleotide stem-loop that leaves 10 residues unpaired (FIG. 9A). The 10 unpaired residues of strand b hybridizes by complementary base-pairing, the 10 3′-terminal nucleotides of stand a. The 5′-end of strand b is terminated with a triphosphate as a consequence of in vitro transcription.

The pool is initialized by annealing both strands and forming a nicked 20 nucleotide helix where the 3′-end of strand a is proximal to the 5′-end of strand b, FIG. 9B. Any species that can catalyze the covalent linkage of strand a and strand b, forming a full-length and viable MDV-1 (+)-like RNA template, will become the substrate for Qβ replicase (+) and (−) strand synthesis, as shown in FIG. 9C, showing loss of pyrophosphate, PPᵢ. Incubation of an initialized pool of 3′ and 5′ segments of MDV-1 (+) RNA augmented with degenerate and hybridization sequences, will automatically produce large quantities of active self-ligating ribozymes with no manual intervention.

1. A composition that undergoes autonomous in vitro evolution to produce at least one nucleic acid comprising a nucleotide sequence that has a desired property, which composition comprises
(a) at least one pool comprising a multiplicity of different member nucleic acids, wherein only members comprising a nucleotide sequence with the desired property are effective substrates for amplification; and
(b) reagents for said amplification.

2. The composition of claim 1, wherein said different members are stem-loop nucleic acids wherein said loops contain degenerate nucleotide sequences that are candidates for possessing said desired property,
wherein said desired property is binding a target, and
wherein said composition further includes said target.

3. The composition of claim 2, wherein said reagents for amplification are reagents for Strand Displacement Amplification (SDA).

4. The composition of claim 2, which further includes a nucleic acid cleavage enzyme and wherein the members of the pool contain a cleavage site for said enzyme.

5. The composition of claim 1, wherein said members are circularized single-stranded nucleic acids containing degenerate candidate nucleotide sequences and a cleavage site and wherein said desired property is the ability of said nucleotide sequences to cleave nucleic acids.

6. The composition of claim 5, wherein the circularized nucleic acids are DNA and the cleavage site is a ribonucleotide.

7. The composition of claim 5, wherein said reagents for amplification are those for conducting SDA or Multi-Prime Amplification (MPA).

8. The composition of claim 1, wherein said members are potential substrates for Qβ replicase,
wherein said desired property is ligase activity, and
wherein said reagents for amplification comprise said Qβ replicase.

9. The composition of claim 1, which comprises at least two different pools amplified by different primers and wherein said amplification reagents comprise primers appropriate for each different pool.

10. The composition of claim 1, which further includes oligonucleotides that are the reverse complements of specific, identified unwanted pool species that are known to target autonomous evolution reaction reagents.

11. A method to effect selective production of a nucleic acid that comprises a nucleotide sequence that has a desired property which method comprises incubating the composition of claim 1, and
recovering a member comprising a nucleotide sequence with said property.

12. The method of claim 11, wherein said members are stem-loop nucleic acids wherein said loops contain degenerate nucleotide sequences that are candidates for possessing said desired property,
wherein said desired property is binding a target, and
wherein said composition further includes said target.

13. The method of claim 12, which is preceded by initializing the composition to form stem-loops.

14. The method of claim 12, which comprises altering the stringency conditions during the conduct of said method so as to alter the stringency of binding of the stems of said stem-loops each other or to alter the stringency of binding of the loop to the target.

15. The method of claim 11, wherein said members are circularized single-stranded nucleic acids containing degenerate candidate nucleotide sequences and a cleavage site and wherein said desired property is the ability of said nucleotide sequences to cleave nucleic acids.

16. The method of claim 11, wherein said members are potential substrates for Qβ replicase and wherein said desired property is ligase activity and wherein said reagents for amplification comprise said Qβ replicase.

17. The method of claim 11, which further includes selection for removal of unwanted nucleic acids prior to or during incubation.

18. A method to effect selective production of a nucleic acid that comprises a nucleotide sequence that has a desired property which method comprises incubating the composition of claim 9, and
recovering a member comprising a nucleotide sequence with said property.

19. A multiprime method to amplify nucleic acid molecules (MPA) which comprises treating a single-stranded nucleic acid template with a set of primers each of which hybridizes to said template at a different location on said template, and
wherein each primer has a double-stranded portion upstream of a single-stranded hybridizing portion,
wherein said treating is in the presence of a polymerase.
